(19) United States
(12) Patent Application Publication
(10) Pub. No.: US 2024/0328946 A1
(43) Pub. Date: Oct. 3, 2024

(54) FLUORESCENCE ANALYSIS METHOD FOR LITHIUM ION DETERMINATION USING FREE-BASE PHTHALOCYANINE (FBPc) AS MOLECULAR PROBE

(71) Applicant: Xiamen University, Xiamen (CN)

(72) Inventors: Donghui LI, Xiamen (CN); Yan ZHANG, Xiamen (CN); Ping HUANG, Xiamen (CN); Yabin DENG, Xiamen (CN)

(73) Assignee: Xiamen University, Xiamen (CN)

(21) Appl. No.: 18/267,586

(22) PCT Filed: Oct. 13, 2022
(86) PCT No.: PCT/CN2022/124988

§ 371 Date: Jun. 15, 2023

(30) Foreign Application Priority Data
Nov. 30, 2021 (CN) 202111437631.6

(51) Int. Cl. G01N 21/64

(52) U.S. Cl. CPC G01N 21/643; G01N 2201/06193; G01N 2201/127

(57) ABSTRACT

The present disclosure provides a fluorescence analysis method for lithium ion determination using free-base phthalocyanine (FBPc) as a molecular probe, and relates to the technical field of fluorescent probes. The method includes the following steps: adding an alkaline organic medium separately into a plurality of reaction vessels, and adding a phthalocyanine organic solution having a same volume as that of the alkaline organic medium; adding lithium ion organic solutions with increasing concentrations in sequence; diluting an obtained reaction system, allowing to stand to conduct a reaction, scanning a fluorescence spectrum of the reaction system, and determining a relative fluorescence intensity at a fluorescence peak. A determination principle is that in organic media, especially an alkaline organic medium, lithium ions can react with the FBPc to emit strong red fluorescence, and generation of the fluorescence has the remarkable characteristics of ultra-sensitivity and high specificity.

### CROSS-REFERENCE TO RELATED APPLICATION

The present application is a national stage application of International Patent Application No. PCT/CN2022/124988, filed on Oct. 13, 2022, which claims priority to the Chinese Patent Application No. CN202111437631.6, filed with the China National Intellectual Property Administration (CNIPA) on Nov. 30, 2021, and entitled “FLUORESCENCE ANALYSIS METHOD FOR LITHIUM ION DETERMINATION USING FREE-BASE PHTHALOCYANINE (FBPc) AS MOLECULAR PROBE”, which is incorporated herein by reference in its entirety.

### TECHNICAL FIELD

The present disclosure relates to the technical field of fluorescent probes, in particular to a fluorescence analysis method for lithium ion determination using free-base phthalocyanine (FBPc) as a molecular probe.

### BACKGROUND

Lithium is widely used in industry, medicine, chemical industry and other fields. Lithium ion batteries have many advantages such as light weight and long service life. The development of electric vehicles and other portable electronics industries has drawn much attention to the application of lithium in the battery industry [Li, L. et al. Prog Nat Sci-Mater, 2019, 29 (2): 111-118. Tan, Y. Z. et al. Small, 2017, 13 (48). Guo, X. J. et al. Russ J Phys Chem., 2019, 93 (3): 584-587.]. Lithium salts are widely used as thickeners for lithium-based greases. In this way, lubricants have suitable consistency, rheological properties, and tribological properties [Ge, X. Y. et al. Tribology, 2015, 35 (3): 254-258. Paszkowski, M. et al. I. Tribol Lett, 2014, 56 (1): 107-117.], and are widely used in airplanes, trains, automobiles, and tanks. In the medical field, lithium has a protective effect on nerve damages. Accordingly, the lithium is commonly used in the treatment of neurodegenerative diseases such as Parkinson's disease, Alzheimer's disease, Huntington's disease, and amyotrophic lateral sclerosis [Basselin, M. et al. Neuropsychopharmacol, 2006, 31 (8): 1659-1674]. Lithium also contributes to re-demyelination and axon regeneration [Makoukji, J. et al. Pro. Natl Acad Sci USA, 2012, 109 (10): 3973-3978] and is widely used in the treatment of bipolar disorder. Lithium is a standard against which other medications for the bipolar disorder are measured [Young, A. H. et al, Brit J Psychiat, 2007, 191:474-476].

Commonly-used lithium determination methods include mass spectrometry (MS) [Cloete, K. J. et al. Anal Methods-Uk, 2017, 9 (36): 5249-5253], high-performance liquid chromatography (HPLC) [Schultz, C. et al. Rsc Adv, 2017, 7 (45): 27853-27862], galvanostatic intermittent titration technique (GITT) [Prosini, P. P. et al. Solid State Ionics, 2002, 148 (1-2): 45-51], inductively coupled plasma-mass spectrometry (ICP-MS) [Moriguti, T. Geostand Geoanal Res, 2004, 28 (3): 371-382], inductively coupled plasma-atomic emission spectroscopy (ICP-AES) [Banno, M. et al. Anal Chim Acta, 2009, 634 (2): 153-157], gas chromatography (GC) [Wang, Z. J Anal Atom Spectrom, 2013, 28 (2): 234-240], and spectrophotometry [Albero, M. I. et al. Sensor Actuat B-Chem, 2010, 145 (1): 133-138]. These methods generally require large-scale instruments or tedious procedures. Therefore, it is of great practical significance to develop a simple, sensitive, and selective quantitative detection method for lithium ions.

Free-base phthalocyanine (FBPc) is a phthalocyanine compound with no coordination atom in its macrocyclic center, and can form complexes with more than 70 elements. Traditionally, elemental phthalocyanine compounds are mostly used as high-quality blue and green dyes. Since the end of the last century, use of the elemental phthalocyanine compounds in various high-tech fields has increased rapidly, such as molecular sensing, efficient catalysis, optical data storage, photodynamic cancer therapy, and molecular conductors/semiconductors [Liu, X. et al. Chem Phys Lett, 2003, 379 (5-6): 517-525]. However, the development and application of FBPc as a molecular probe is still rarely reported.

### SUMMARY

An objective of the present disclosure is to provide a fluorescence analysis method for lithium ion determination using FBPc as a molecular probe. The method has high sensitivity, strong specificity, and desirable stability, and has a determination wavelength in a long-wavelength region of visible light and a low photobleaching effect. The method can significantly eliminate the interference of background fluorescence and scattered light that may exist in actual samples, and is based on the strong red fluorescence emitted by a reaction of the FBPc with lithium ion.

The present disclosure provides a fluorescence analysis method for lithium ion determination using FBPc as a molecular probe, including the following steps: adding an alkaline organic medium separately into a plurality of reaction vessels, and adding an FBPc organic solution having a same volume as that of the alkaline organic medium in each of the reaction vessels; adding lithium ion organic solutions with increasing concentrations in sequence; diluting an obtained reaction system, allowing to stand to conduct a reaction, scanning a fluorescence spectrum of the reaction system, and determining a relative fluorescence intensity at a fluorescence peak.

Further, there are no less than three reaction vessels.

Further, the alkaline organic medium is selected from the group consisting of an alkaline organic solvent and an alkaline mixed solvent including an alkaline organic substance and an organic solvent.

Further, the alkaline organic solvent or the alkaline organic substance in the alkaline mixed solvent is selected from but not limited to the group consisting of diethylamine, triethylamine, butylamine, ethanolamine, isopropylamine, pyridine, hexahydropyridine, morpholine, quinoline, benzothiazole, tetramethylethylenediamine, triethylenetetramine, and N,N-dimethyl-1,3-diaminopropane.

Further, an organic solvent of the FBPc organic solution has a relatively high solubility to the FBPc, and is selected from the group consisting of N,N-dimethylformamide (DMF), dimethyl sulfoxide (DMSO), sulfolane, chlorobenzene, and quinoline.

Further, an appropriate volume of the FBPc organic solution is added to achieve a final concentration between 5.0×10⁻⁷ mol/L to 2.0×10⁻⁶ mol/L; and phthalocyanine in the FBPc organic solution has a molecular formula of C₃₂H₁₈N₈g.

The phthalocyanine has the following structural formula:

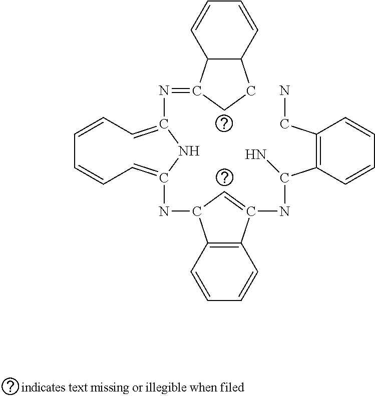 [SMILES: NCc1ccccc1C(N)NC1=CC(Nc2ccccccc(/N=C3\CCC4C=CC=CC34)[nH]2)c2ccccc21]

Further, serial concentrations of the lithium ion organic solutions fall within a linear range of a corresponding working curve; and the linear range of the corresponding calibration curve refers to a calibration curve range corresponding to determination of a lithium ion concentration determined by a concentration of the FBPc organic solution.

Further, the reaction system is allowed to stand to conduct the reaction for not less than 60 min.

Further, the relative fluorescence intensity is determined at the fluorescence peak in a wavelength range of 660 nm to 710 nm.

In the present disclosure, the involved reactions are conducted in an organic medium. In the organic medium, phthalocyanine (that is, FBPc) without a coordination atom in its center has extremely weak fluorescence. In the presence of lithium ions, the phthalocyanine and the lithium undergo coordination to form lithium phthalocyanine.

It is found that an organic solution of the lithium phthalocyanine emits highly strong red fluorescence under the excitation of ultraviolet light or light with a wavelength above 605 nm, and has a maximum emission wavelength of around 673 nm. Accordingly, a novel fluorescence analysis method is established for ultrasensitive and highly-specific lithium ion determination using FBPc as a fluorescent probe.

Compared with the prior art, the present disclosure has the following outstanding advantages:

1) The ultrasensitive and highly-specific fluorescence analysis method for the lithium ion determination using FBPc as a fluorescent probe has not been reported, and is proposed for the first time.

2) The method has extremely high detection sensitivity. Based on the lithium ion determination method established by the present disclosure, a detection limit is as low as 5.0×10⁻¹⁰ mol/L, or 4.25×10⁻⁹ g/L, or 4.25×10⁻¹² g/mL. That is, the method has a detection limit reaching the ppt level, and is better than those reported in the literature.

3) The method has strong specificity. The common 18 metal ions do not interfere with the method.

4) The method has an excellent linear response. The calibration curve has a correlation coefficient of approximately 0.9999.

5) The method is easy to operate and can realize visual observation. A 5.0×10⁻⁷ mol/L lithium ion solution can easily present visible red fluorescence, and is highly beneficial for on-site analysis.

6) The method has a determination wavelength of greater than 670 nm, which is located in a long-wavelength region of visible light. Since scattered light is proportional to a fourth power of the wavelength, the method can effectively avoid the interference of scattered light during determination. Since there is extremely low fluorescence emission of natural and synthetic fluorescent substances in the detection wavelength region, the interference of background fluorescence can be avoided.

### BRIEF DESCRIPTION OF THE DRAWINGS

FIG. 1 shows excitation spectra and emission spectra of a reaction system in the presence or absence of lithium ions;

FIG. 2 shows a comparison of fluorescence responses of FBPc to lithium ion and common metal ions;

FIG. 3 shows a stability curve of a determination system; and

FIG. 4 shows a calibration curve for lithium ion determination.

### DETAILED DESCRIPTION OF THE EMBODIMENTS

In the present disclosure, a determination principle is that in organic media, especially an alkaline organic medium, lithium ions can react with the FBPc to emit strong red fluorescence, and generation of the fluorescence has the remarkable characteristics of ultra-sensitivity and high specificity. The present disclosure will be further described by the following examples with reference to accompanying drawings.

In an example of the present disclosure, a determination method includes the following steps:

1) adding an alkaline organic solvent or a mixed solvent including an organic solvent and an alkaline organic substance into a reaction vessel;

2) adding an FBPc organic solution having a same volume as that of the alkaline organic solvent or the mixed solvent in each of the reaction vessels;

3) adding lithium ion organic solutions with increasing concentrations in sequence; and

4) allowing an obtained reaction system to stand, scanning a fluorescence spectrum of the reaction system, and determining a relative fluorescence intensity at a fluorescence peak.

In a plurality of the reaction vessels, lithium ion organic solutions with increasing concentrations are sequentially added, and there are no less than 3 reaction vessels. The serial concentrations of the lithium ion organic solutions fall within a linear range of a corresponding calibration curve. The linear range of the corresponding calibration curve refers to a calibration curve range corresponding to determination of a lithium ion concentration determined by a concentration of the FBPc organic solution.

An appropriate volume of the FBPc organic solution is added to achieve a final concentration between 5.0×10⁻⁷ mol/L and 2.0×10⁻⁶ mol/L. The reaction system is diluted, allowed to stand to conduct a reaction for not less than 60 min, and then the relative fluorescence intensity is determined in a wavelength range of 660 nm to 710 nm.

The phthalocyanine is as follows:

molecular formula: C₃₂H₁₈N₈;

structural formula:

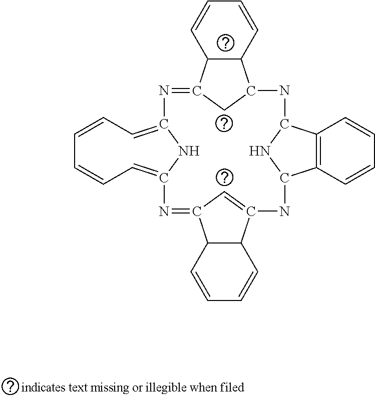 [SMILES: C1=CC2C3=C/C(=N\c4ccccccc([nH]4)/N=C4\CC(NC5NC(N3)c3ccccc35)C3C=CC=CC43)C2C=C1]

The following is an example of experimental manipulations under optimized conditions.

45.0 μL of a phthalocyanine DMF solution with a concentration of 1.0×10⁻⁶ mol/L, a 1.0×10⁻⁴ mol/L lithium chloride DMF solution with a certain volume, and a mixed solvent (a mixed solvent of triethylenetetramine and ethanol, v/v=1:1) with a certain volume were added to a 5.0 mL plastic centrifuge tube successively, such that a total volume was 3.0 mL. A resulting reaction system was mixed evenly, and allowed to stand at a room temperature for 1 h. An emission spectrum was scanned on a fluorescence spectrophotometer and a fluorescence intensity was obtained at 673 nm. The dosage of each component was shown in Table 1.

TABLE 1
Dosage parameters of each component in reaction system

| | | | | | | | | |
|---|---|---|---|---|---|---|---|---|
| Dosage of 1.0 × 10⁻⁶ mol/L | 45.0 | 45.0 | 45.0 | 45.0 | 45.0 | 45.0 | 45.0 | 45.0 |
| phthalocyanine DMF solution (μL) | | | | | | | | |
| Dosage of 1.0 × 10⁻⁴ mol/L lithium | 0.0 | 0.3 | 3.0 | 6.0 | 9.0 | 12.0 | 15.0 | 18.0 |
| chloride DMF solution (μL) | | | | | | | | |
| Dosage of mixed solvent (μL) | 4955 | 4954.7 | 4952 | 4949 | 4946 | 4943 | 4940 | 4937 |

The present disclosure was described in detail below in conjunction with figures and tables.

1) Excitation and fluorescence spectra of the reaction system

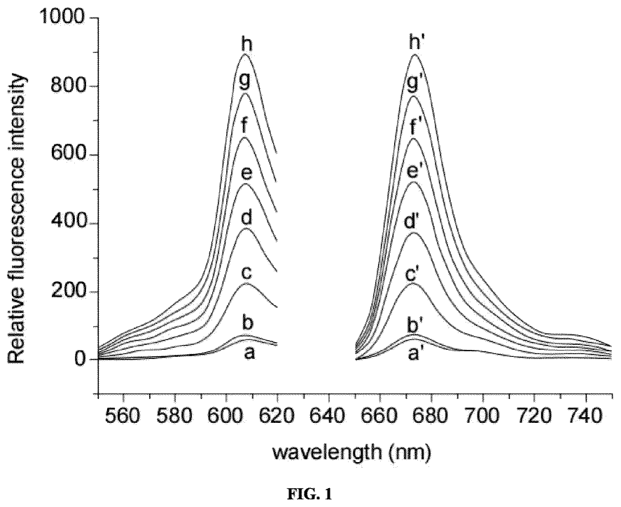

FIG. 1 showed excitation and fluorescence spectra of reaction systems in the presence or absence of lithium ion.

Experiments had found that in a suitable organic medium (such as the mixed solvent of triethylenetetramine and ethanol in the example), FBPc with extremely weak fluorescence emitted strong fluorescence in the presence of lithium ion. Moreover, the fluorescence intensity of the system increased with an increase of the lithium ion concentrations, and the fluorescence peak appeared at 673 nm.

In FIG. 1, a concentration of the FBPc was 1.0×10⁻⁶ mol/L, and concentrations of the lithium ion (10×10⁻⁸ mol/L) were (a) 0, (b) 5, (c) 10, (d) 20, (e) 30, (f) 40, (g) 50, and (h) 60.

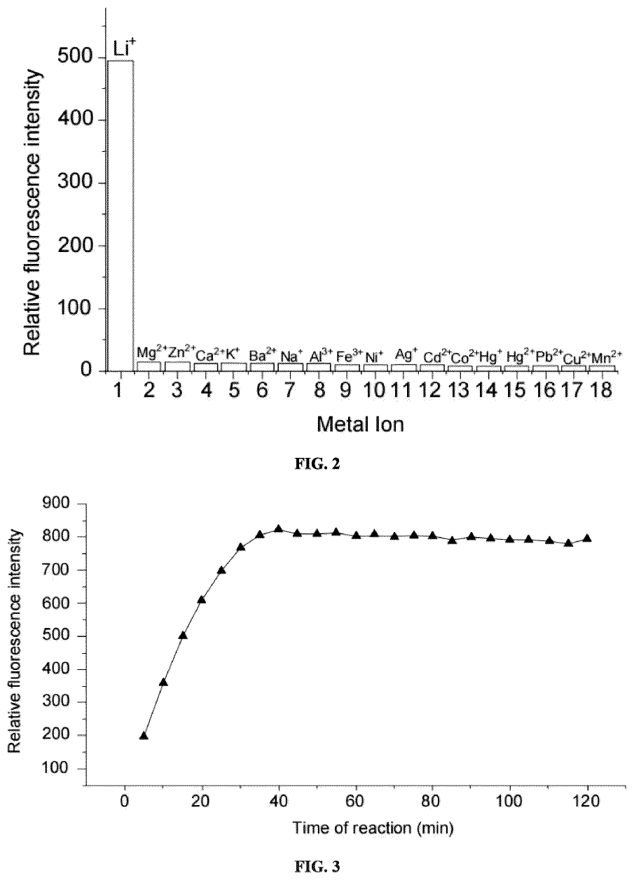

2) FIG. 2 showed a comparison of a fluorescence response of FBPc to lithium ion and common metal ions.

The fluorescence response behavior of FBPc to common metal ions, namely Na⁺, K⁺, Mg²⁺, Al³⁺, Ca²⁺, Ba²⁺, Mn²⁺, Fe³⁺, Ni²⁺, Co²⁺, Cd²⁺, Cu²⁺, Ag⁺, Hg⁺, Hg²⁺, Pb²⁺, and Zn²⁺ was investigated. The results showed that the FBPc had almost no fluorescence response to the above metal ions. However, in the presence of lithium ion, the fluorescence of the reaction system increased dramatically, indicating that FBPc had a highly specific response to the lithium ion. A concentration of each of the metal ions in FIG. 2 was 1.0×10⁻⁶ mol/L.

3) FIG. 3 showed a stability curve of a determination system.

Experimental investigation showed that the system could reach stability after 60 min of reaction. Therefore, in actual work, the reaction for 60 min was conducted before the determination or spectral scanning.

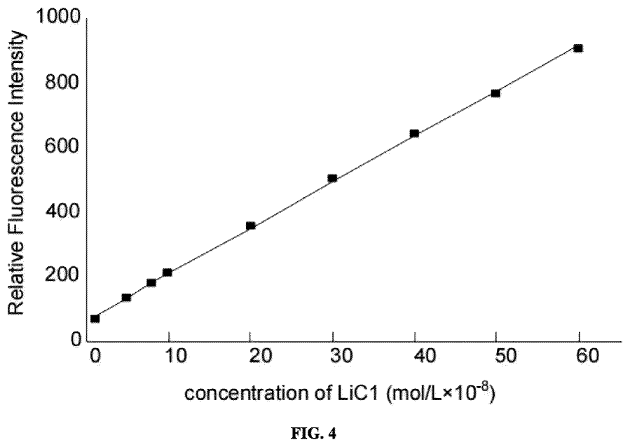

4) FIG. 4 showed a calibration curve for lithium ion determination.

Under the optimized experimental conditions, a calibration curve was established for the lithium ion determination. The curve had a linear regression equation of y=14.2x+53.2 and a linear correlation coefficient of r=0.9995. A response range was 1.0×10⁻⁸ mol/L to 6.0×10⁻⁷ mol/L, and the method had a detection limit of 5.0×10⁻¹⁰ mol/L.

5) Table 2 was the determination results of actual samples.

The present disclosure was applied to the determination of a lithium ion content in lithium carbonate tablets and lithium carbonate sustained-release tablets, which are commonly used drugs for treating mania. Lithium carbonate, a main drug in the lithium carbonate tablet or lithium carbonate sustained-release tablet, is not soluble in the DMF or mixed solvent, and a solid drug contains other insoluble substances. Therefore, pretreatment of the samples is required. The pretreatment specifically included: 20 tablets of the lithium carbonate tablets or lithium carbonate sustained-release tablets were taken, a total mass was weighed, and then the tablets were fully ground in a mortar. 0.5000 g of an obtained fine powder was placed in a beaker, 40.0 mL of 1.0 mol/L hydrochloric acid was added to fully react, and insoluble matters were removed by filtration. A resulting filtrate was heated at 200°° C. to evaporate the hydrochloric acid to dryness, to obtain a solid. The solid was dissolved in DMF and diluted to 25.0 mL, and then 5.0 μL of a resulting DMF solution was pipetted and diluted to 25.0 mL.

TABLE 2
Determination results of actual samples.

| | Labeled | | Relative | Relative standard |
|---|---|---|---|---|
| | amount | Determination | error | deviation RSD |
| Drug name | (g) | results (g) | (%) | (%, n = 5) |
| Lithium | 0.30 | 0.32 | 6.7 | 0.52 |
| carbonate | | | | |
| sustained-release | | | | |
| tablet | | | | |
| Lithium | 0.25 | 0.25 | −2.6 | 0.09 |
| carbonate tablet | | | | |

15.0 μL of a pretreated sample solution was pipetted, and the experimental operation and detection were conducted step by step. A content of lithium carbonate in the tablets was calculated according to the determined results, and the content was compared with the labeled amount. The obtained results were listed in Table 2. The results showed that the determination results of the present disclosure had extremely high accuracy.

Certainly, the above-mentioned examples are merely preferred examples of the present disclosure and are not to be construed as limiting the scope of the examples of the present disclosure. Any equivalent modifications, improvements, and the like made within the application scope of the present disclosure should fall within the protection scope of the present disclosure.

1. A fluorescence analysis method for lithium ion determination using free-base phthalocyanine (FBPc) as a molecular probe, comprising the following steps:
adding an alkaline organic medium separately into a plurality of reaction vessels, and adding an FBPc organic solution having a same volume as that of the alkaline organic medium in each of the reaction vessels; adding lithium ion organic solutions with increasing concentrations in sequence; diluting an obtained reaction system, allowing to stand to conduct a reaction, scanning a fluorescence spectrum of the reaction system, and determining a relative fluorescence intensity at a fluorescence peak.

2. The fluorescence analysis method for lithium ion determination using FBPc as a molecular probe according to claim 1, wherein there are no less than three reaction vessels.

3. The fluorescence analysis method for lithium ion determination using FBPc as a molecular probe according to claim 1, wherein the alkaline organic medium is selected from the group consisting of an alkaline organic solvent and an alkaline mixed solvent comprising an alkaline organic substance and an organic solvent.

4. The fluorescence analysis method for lithium ion determination using FBPc as a molecular probe according to claim 3, wherein the alkaline organic solvent or the alkaline organic substance in the alkaline mixed solvent is selected from but not limited to the group consisting of diethylamine, triethylamine, butylamine, ethanolamine, isopropylamine, pyridine, hexahydropyridine, morpholine, quinoline, benzothiazole, tetramethylethylenediamine, triethylenetetramine, and N,N-dimethyl-1,3-diaminopropane.

5. The fluorescence analysis method for lithium ion determination using FBPc as a molecular probe according to claim 4, wherein when the alkaline organic substance in the alkaline mixed solvent is the triethylenetetramine, the organic solvent in the alkaline mixed solvent is anhydrous ethanol.

6. The fluorescence analysis method for lithium ion determination using FBPc as a molecular probe according to claim 5, wherein the triethylenetetramine and the anhydrous ethanol are at a volume ratio of 1:1.

7. The fluorescence analysis method for lithium ion determination using FBPc as a molecular probe according to claim 1, wherein an organic solvent of the FBPc organic solution has a relatively high solubility to the FBPc, and is selected from the group consisting of N,N-dimethylformamide (DMF), dimethyl sulfoxide (DMSO), sulfolane, chlorobenzene, and quinoline.

8. The fluorescence analysis method for lithium ion determination using FBPc as a molecular probe according to claim 1, wherein an appropriate volume of the FBPc organic solution is added to achieve a final concentration between 5.0×10⁻⁷ mol/L and 2.0×10⁻⁶ mol/L; and phthalocyanine in the FBPc organic solution has a molecular formula of C32H18N8.

9. The fluorescence analysis method for lithium ion determination using FBPc as a molecular probe according to claim 1, wherein serial concentrations of the lithium ion organic solutions fall within a linear range of a corresponding working curve; and the linear range of the corresponding calibration curve refers to a calibration curve range corresponding to determination of a lithium ion concentration determined by a concentration of the FBPc organic solution.

10. The fluorescence analysis method for lithium ion determination using FBPc as a molecular probe according to claim 9, wherein a linear regression equation of the calibration curve is y=14.2x+53.2, and a linear correlation coefficient is r=0.9995; x is the lithium ion concentration, and y is the relative fluorescence intensity; and
a response range is 1.0×10-8 mol/L to 6.0×10-7 mol/L.

11. The fluorescence analysis method for lithium ion determination using FBPc as a molecular probe according to claim 1, wherein the reaction system is allowed to stand to conduct the reaction for not less than 60 min.

12. The fluorescence analysis method for lithium ion determination using FBPc as a molecular probe according to claim 1, wherein the relative fluorescence intensity is determined at the fluorescence peak in a wavelength range of 660 nm to 710 nm.

13. The fluorescence analysis method for lithium ion determination using FBPc as a molecular probe according to claim 1, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

14. (canceled)

15. The fluorescence analysis method for lithium ion determination using FBPc as a molecular probe according to claim 2, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

16. The fluorescence analysis method for lithium ion determination using FBPc as a molecular probe according to claim 3, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

17. The fluorescence analysis method for lithium ion determination using FBPc as a molecular probe according to claim 4, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

18. The fluorescence analysis method for lithium ion determination using FBPc as a molecular probe according to claim 5, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

19. The fluorescence analysis method for lithium ion determination using FBPc as a molecular probe according to claim 6, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

20. The fluorescence analysis method for lithium ion determination using FBPc as a molecular probe according to claim 7, wherein a sample solution is subjected to experimental operation and detection according to the following steps:
1) adding the alkaline organic solvent or the alkaline mixed solvent comprising the alkaline organic substance and the organic solvent into a reaction vessel;
2) adding the FBPc organic solution into the reaction vessel;
3) adding the sample solution into the reaction vessel; and
4) allowing an obtained reaction system to stand, scanning the fluorescence spectrum of the reaction system, and determining the relative fluorescence intensity at the fluorescence peak; and
calculating a lithium ion content in the sample solution according to obtained determined results.

21. The fluorescence analysis method for lithium ion determination using FBPc as a molecular probe according to claim 1, wherein the fluorescence analysis method has a detection limit of 5.0×10⁻¹⁰mol/L, 4.25×10⁻⁹ g/L, or 4.25×10 ⁻¹² g/mL.
